(19) United States
(12) Patent Application Publication
(10) Pub. No.: US 2020/0111087 A1
(43) Pub. Date: Apr. 9, 2020

(54) METHOD FOR ENCRYPTING DIGITAL CONTRACT DOCUMENT BETWEEN CONTRACTORS

(71) Applicant: Jinlei Zhou, Diamond Bar, CA (US)

(72) Inventor: Jinlei Zhou, Diamond Bar, CA (US)

(21) Appl. No.: 16/154,241

(22) Filed: Oct. 8, 2018

(51) Int. Cl. G06Q 20/38; G06F 17/30; H04L 9/06; H04L 9/32

(52) U.S. Cl. CPC G06Q 20/382; G06F 17/30283; G06Q 50/18; H04L 9/3213; H04L 9/0643

(57) ABSTRACT

The present application discloses a method for encrypting digital contract document between contractors, comprising: initiating a video signature by contractors of the participants; generating a hash code; generating a legal agreement, wherein the hash code is displayed at the legal agreement; and recording while reading the hash code at the legal agreement orally. The step of generating the hash code further comprises generating first tokens for the contractors of the participants. In addition, after recording while reading the hash code at the legal agreement orally, the method further comprises: accepting invitation for signing by attesting witness; signing for verification by the attesting witness; converting all procedure to data; uploading the data to a cloud system; generating a receipt with a hash code and backed up tokens; scanning the hash code to view the digital contract document; distributing the backed up tokens to the attesting witness.

### TECHNICAL FIELD OF THE INVENTION

The present application generally relates to contract encryption, and more particularly, to a method for encrypting digital contract document between contractors.

### BACKGROUND OF THE INVENTION

In current market, the most common way to verify the authenticity of electronic documents is to use digital signature, which is typically accomplished using some form of asymmetric cryptography. However, many different form of digital signature comprises critical problems. For example, PKI-based (Public Key Infrastructure-based) digital signature only can be used as a short-term key since any signatures created with the key can no longer be relied on once the key is compromised.

Since current methods generally comprise serious problems, a need remains for a method for encrypting digital contract document between contractors to provide an improved transactional environment, and further protect and restore relative evidence for signature site.

### SUMMARY OF THE INVENTION

The present application discloses a method for providing a method for encrypting digital contract document between contractors to provide an improved transactional environment.

The method for encrypting digital contract document between contractors comprises: uploading a digital document to a system by at least one contractor; initiating video signatures by the contractors; generating respective hash codes by the system for each of the video signatures; generating legal agreements by the system, wherein the respective hash code is displayed at each of the legal agreements; and recording while reading the respective hash codes at the legal agreements orally by the contractors.

According to an exemplary embodiment, wherein the step of generating the respective hash codes by the system for each of the video signatures further comprises generating respective tokens by the system, wherein the respective hash codes are implanted into the respective tokens by the system.

According to the other exemplary embodiment, wherein the step of generating the respective hash codes by the system for each of the video signatures further comprises generating respective tokens by the system; and storing the respective tokens under names of the contractors respectively at the system.

In various exemplary embodiments, wherein after recording while reading the respective hash codes at the legal agreements orally by the contractors, the method further comprises: converting all procedure to data; uploading the data to a cloud system; generating receipts and backed up tokens, wherein the backed up tokens are the same as the respective tokens; and distributing the receipts and the backed up tokens to the contractors.

According to an exemplary embodiment, wherein the step of generating the receipts and the backed up tokens comprises generating a hash code for each of the receipts, wherein the hash code may be a QR hash code.

According to the other exemplary embodiment, wherein after generating the receipts and the backed up tokens, the method further comprises scanning the hash code to view the digital contract document.

According to the other exemplary embodiment, wherein after distributing the backed up tokens to the contractors, the method further comprises deleting the digital contract document on the cloud system by using the tokens or the backed up tokens from the contractors.

According to the other exemplary embodiment, wherein after distributing the receipts and the backed up tokens to the contractors, the method further comprises storing the backed up tokens under names of the contractors at the system.

In various exemplary embodiments, wherein after uploading the digital document to the system by the at least one contractor, the method further comprises sending an invitation by the contractors to an attesting witness: and accepting the invitation by the attesting witness.

According to an exemplary embodiment, the step of initiating the video signatures by the contractors comprises initiating the video signatures by the contractors and the attesting witness. The step of generating the respective hash codes by the system for each of the video signatures further comprises generating respective tokens for the contractors and the attesting witness by the system. The step of generating the respective tokens for the contractors and the attesting witness by the system comprises implanting the respective hash codes into the respective tokens by the system. After generating the respective tokens for the contractors and the attesting witness, the method further comprises storing the respective tokens under names of the contractors and the attesting witness respectively at the system.

According to the other exemplary embodiment, the step of recording while reading the respective hash codes at the legal agreements orally by the contractors comprises recording while reading the respective hash codes at the legal agreements orally by the contractors and the attesting witness.

Based on the above, the present application improves the authenticity of the digital documents by utilizing visual and audio verifications. Specifically, the hash codes are unreplaceable since the hash code represents the initiating time of the video, creating an uncompromised key for the digital contract documents. In addition, a recording procedure may also provide a second protection for the digital contract documents since the hash codes, tones, and frequencies of each involved members are different. Simply put, the present application utilizes distributed ledger function in blockchain to restore the signature site by saving the video with the hash code, protecting the relative evidence.

Furthermore, the original documents can have better protection because the tokens from every parties such as the contractors and/or the attesting witness are required for deleting, reducing the dispute caused by unilateral deletion of the digital contract document.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIG. 1 is a general flow chart of a method for encrypting digital contract document between contractors.

FIG. 2 is a flow chart showing an initiating step thereof.

FIG. 3 is a flow chart showing a contracting step thereof.

FIG. 4 is a flow chart showing an attesting witness step thereof.

FIG. 5 is a flow chart showing a cloud system step thereof.

FIG. 6 is a flow chart showing a self-transaction step within the contracting step and the cloud system step.

FIG. 7 is a flow chart showing a deleting step thereof.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

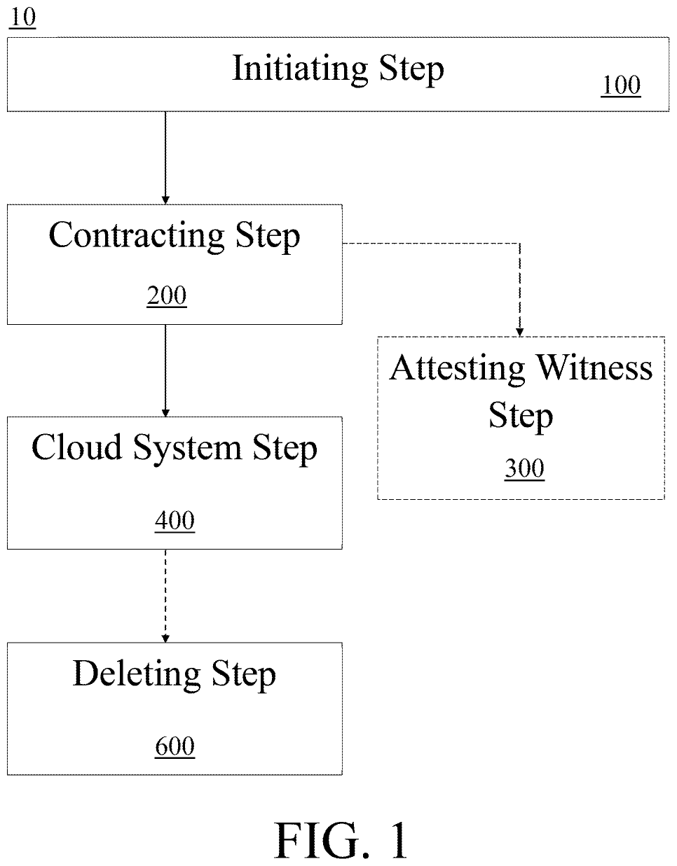

FIG. 1 is a general flow chart of a method 10 for encrypting digital contract document between contractors.

It should be noted that the participants in the present application mainly represent the contractors. For some situations such as the special requirement from the contractors, the attesting witness may be involved for notary purpose, the present application is not limited thereto.

Referring to FIG. 1, the method 10 comprises an initiating step 100, a contracting step 200, a cloud system step 400 and an optional deleting step 600. In addition, if necessary, an attesting witness step 300 may also be involved in the present application.

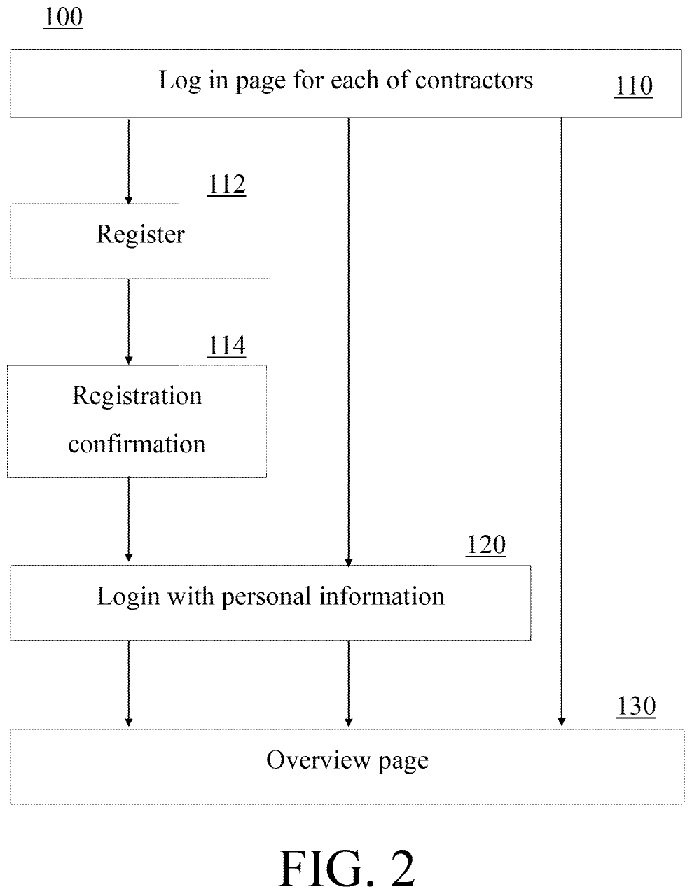

FIG. 2 is a flow chart showing the initiating step 100 of the method 10 for encrypting digital contract document between the contractors.

Referring to FIG. 2, as shown in step 110 the first step of the initiating step 100 is logging in by each of the contractors. Next, if the contractors have not registered before, the website will show a register page for registration as shown in step 112. The present application utilize email for registration. The contractors may enter their email address for receiving a verification email as shown in step 114. However, the present application is not limited, the contractors may utilize other manners for registration such as entering phone number to receive text message or answering the voice mail. Then, as shown in step 120, the contractors may login with their personal information such as email address and password.

If the contractors have registered before, the system may save cookies for auto login for the next time. In other word, the contractors may simply by clicking confirmation to login.

Or, the contractors can select automatically log in for next time. Therefore, if the contractors enter the website, the system may automatically remember the accounts and passwords.

As shown in step 130, the overview page is shown after logging in.

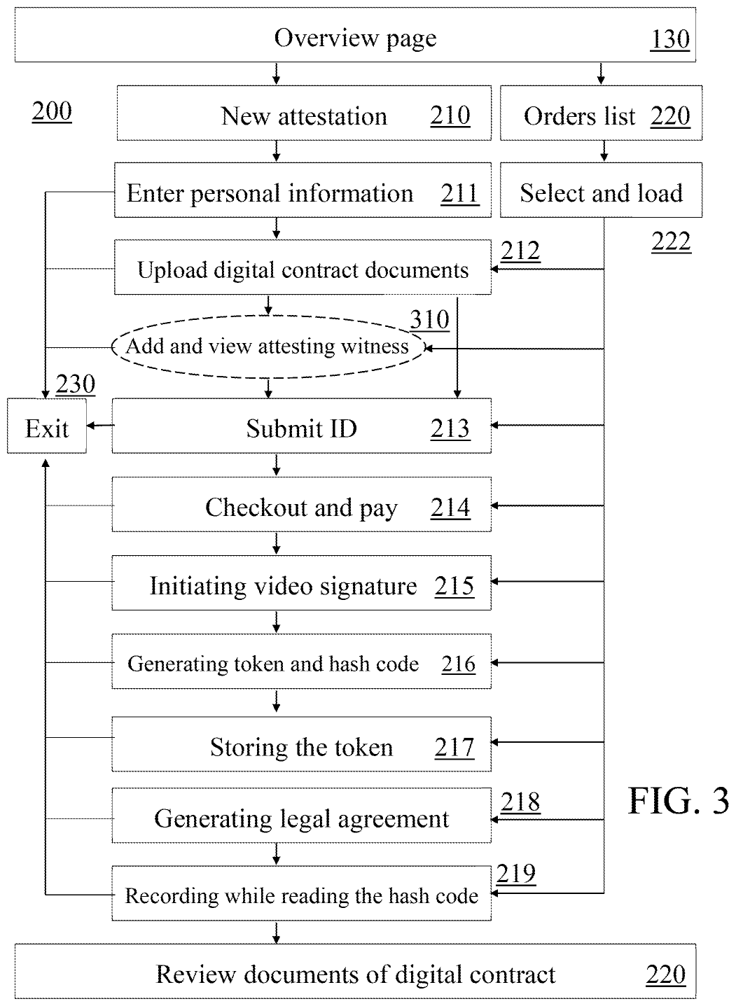

FIG. 3 is a flow chart showing the contracting step 200 of the method 10 for encrypting digital contract document between the contractors.

The overview page 130 has two options, new attestation as shown in step 210 or showing orders list as shown in step 220.

If selecting to start a new attestation, it is required for the contractors to enter their personal information as shown in step 211. For example, the personal information may be frill name, birth date or address, the present application is not limited thereto. Next, the contractors may upload contracting documents and sign as shown in step 212.

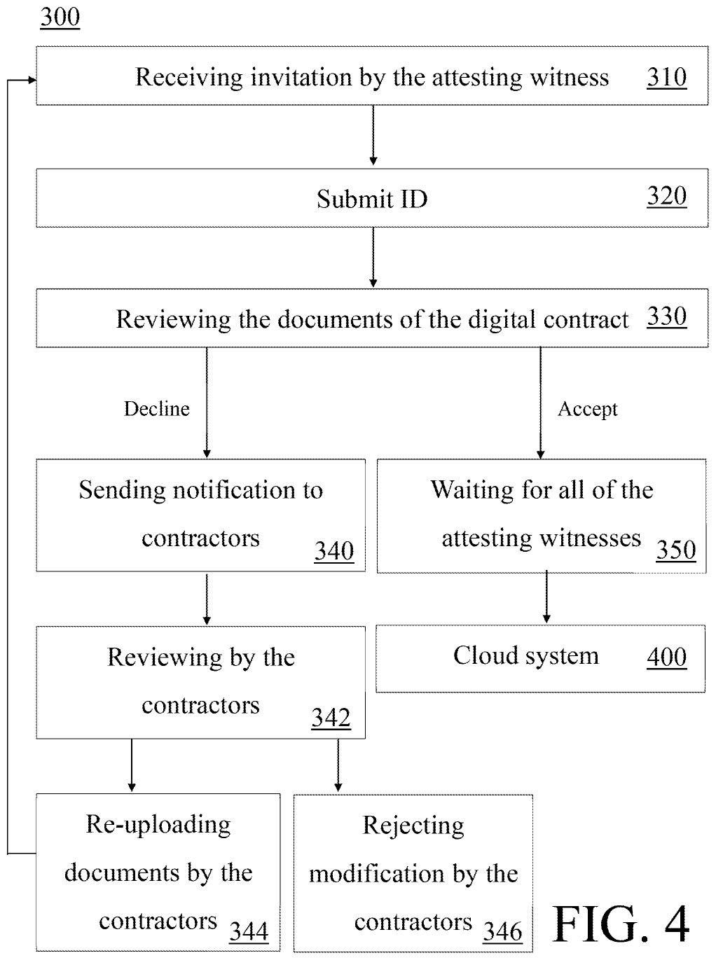

Referring to an optional step 310, the contractors may add attesting witness for notary if required, the present application is not limited thereto. At the step 310, the contractors may send invitation to the attesting witness. The contractors may also view all members of attesting witness at this step 310 to modify the list of attesting witness. The detail of the notary procedure will be described with FIG. 4.

Next, submit ID for verification as shown in step 213. Specifically, the step 213 is a verification step for confirming the authenticity of every involved member. After that, referring to step 214, a checkout and pay page may be shown. The contractors can pay by credit card, debit card, check or PayPal, the present application is not limited in checking manners.

As shown in step 215, a video signature is initiated by each of the contractors. The video signature is designed to create an unchangeable, unreproducible, and unforgettable signature.

Referring to step 216, the system may generate tokens for the contractors and a hash code after initiating the signature. The hash code is assigned to the document uploaded by the contractors, representing a specific time when the documents is reviewed and signed by the contractors. Therefore, the hash code is unchangeable and cannot be replaced since it represents the specific time.

It should be noted that the contractors in the present application is not limited in only two contractors. Actually, the contractors in the present application can be more than two contractors, depending on each of the contract. Therefore, the claim term “respective hash codes” means different hash codes generated for each of the contractors. For example, the respective hash codes may mean the first hash code for the first contractor, the second hash code for the second contractor, the third hash code for the third contractor etc., the present application is not limited thereto.

Furthermore, the hash code is implanted into the tokens, which is capable of deleting the contract. It should be noted that not only the hash code generated after initiating the video may be implanted into the tokens, the hash code existed along with the digital contract document may also be implanted into the tokens at this step, the present application is not limited thereto. Simply put, two hash codes may be generated after uploading the digital contract document and initiating the video.

The cryptographic hash function used to generate hash code in the present application is called Hash-based Message Authentication Code (HMAC) Secure Hash Algorithms (SHA)-256, which is a type of keyed hash algorithm created from SHA-256 hash function. The present application may generate a unique, fixed size 256-bit (32 byte) hash by SHA-256. HMAC is a specific type of message authentication code containing a cryptographic hash function (in the algorithm of the present application is SHA-256) and a secret cryptographic key.

SHA-256, as described above, is a 256-bit hash function which is designed to provide 128 bits of security against collision attacks. To generate SHA-256 hash, the message is padded with its length in such a way that the result is a multiple of 512 bits long at first, and parsed into 512-bit message blocks M⁽¹⁾, M⁽²⁾, . . . , M_{(N)} afterwards. The message block are processed one at a time: Beginning with a fixed initial hash value H⁽⁰⁾, sequentially compute

H⁽ⁱ⁾=H⁽¹⁻¹⁾+C_{M}_{⁽ⁱ⁾}(H⁽ⁱⁱ⁻¹⁾),

Where C is the SHA-256 compression function and +means word-wise mod 2³² addition. H^{(N)} is the hash of M.

HMAC will combine hash code generated from SHA-256 and a customized secret cryptographic key. HMAC uses two passes of hash computation. The secret key is used to derive two keys—inner and outer at first. The first pass of the algorithm produces an internal hash derived from the message and the inner key. The second pass produces the final HMAC code derived from the inner hash result and the outer key. Thus the algorithm provides better immunity against length extension attacks. A HMAC code can be generated by computing

$$HMAC ( K , m ) = H ( ( {K}^{′} ⊕ opad ) ‖ H ( ( {K}^{′} ⊕ ipad ‖ m ) ) \\ {K}^{′} = \{ \begin{matrix}H ( K ) K is larger than blocksize \\ K otherwise\end{matrix}$$

Where H is a cryptographic hash function, m is the message to be authenticated, K is the secret key, K′ is a block-sized key derived from the secret key, K; either by padding to the right with 0s, unto the block size, or by hashing down to the block size. ∥ denotes concatenation, ⊕ denotes bitwise exclusive or (XOR), ipad is the outer padding, consisting of repeated bytes valued 0×5c, up to the block size, and ipad is the inner padding, consisting of repeated bytes, valued 0×36, up to the block size.

The result of the formula computation is the required hash code, which will be used as the unique identifier of the documentation or the video signature.

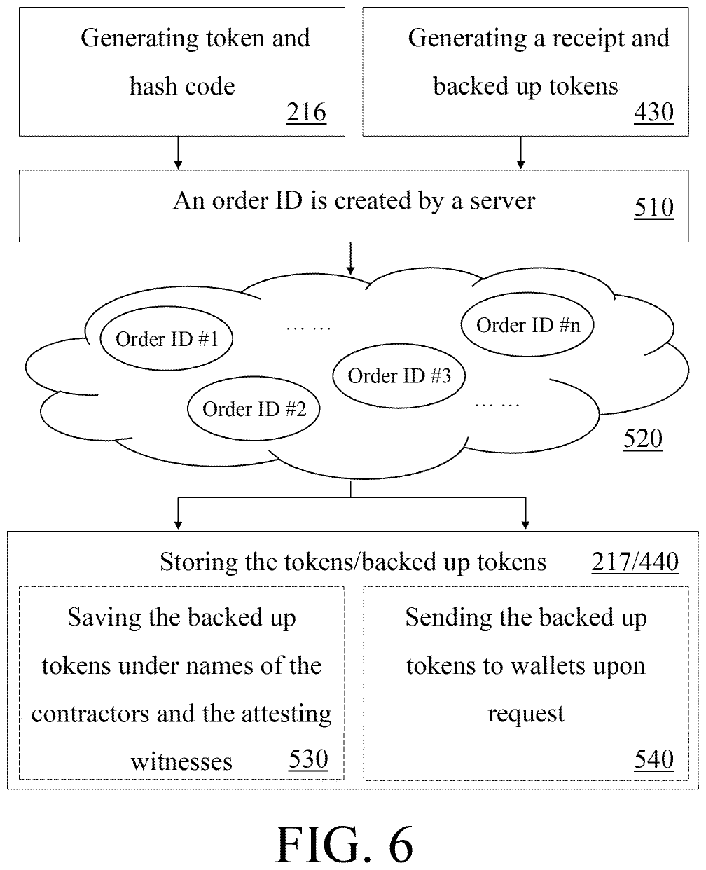

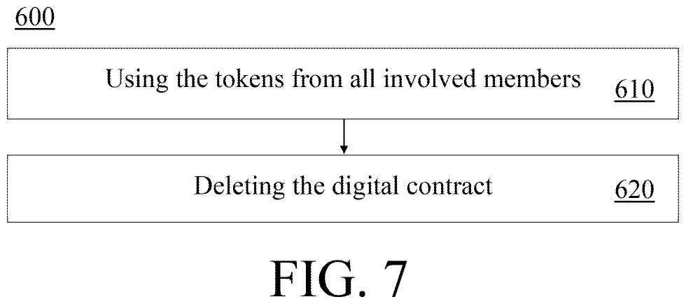

The detail of the token will be described with FIGS. 6-7.

After implanting the hash code into the tokens, the token may be transacted at the blockchain, allowing the token to be recorded into other nodes of the entire blockchain. Specifically, since the process for effecting distributed ledger is recording the transaction by the contractors and the attesting witness, so a transaction must be done in order to synchronize with the entire blockchain network.

The present application utilizes this concept to record the token into the blockchain. In detail, the token may self-transact after implanting the hash code into the token, allowing the token to be recorded into the whole blockchain network.

As shown in step 217, the tokens may be stored under names of each of the contractor automatically or under request. The detail about storing the token and self-transaction will be described with FIG. 6.

Referring to step 216, a legal agreement is generated after generating the token and the hash code. Specifically, the legal agreement comprises the acknowledgement of the signed documents of the contractors. In addition, the hash code is also displayed on the legal agreement. It should be noted that the hash code displayed on the legal agreement can be the original hash code or a shortened hash code for easily reading. The present application is not limited as long as the hash code for each of the involved members are different.

Next, recording while reading the hash code at the legal agreement as shown in step 219. In detail, it is required for the contractors to orally read out the hash code, wherein the hash code is only validated in a limited time for security purpose. The purpose of reading the hash code is not only for security, but also prove the intention and acknowledgement of the contractors.

By doing so, the system may generate two unique information representing the specific time of initiating the video signature and the specific time of recording. In addition, each of the involved members may even provide different tones and frequencies when recording, providing a second protection for authenticity. Therefore, an unchangeable and unreproducible key for the digital contract document is created.

Referring to step 230, between the step 211 and the step 219, the contractors can exit the process at any time they want. If the contractors want to enter the previous process, they can select the desired order at the orders list as shown in the step 220. After selecting and loading as shown in step 222, the system may jump to the previous process where the contractors exited.

Referring to step 220, the contractors may review all documents of the digital contract document.

FIG. 4 is a flow chart showing the optional attesting witness step 300 of the method 10 for encrypting digital contract document between contractors.

It should be noted that the term of attesting witness in the present application is not limited in a person in a neutral position, the attesting witness can be other beneficial parties as well.

As shown in step 310, the attesting witness may receive invitation of notary for the digital contract document. After that, the attesting witness may submit ID for reviewing the documents of the digital contract document as shown in step 320 and step 330. The present application utilize email as a media for receiving and sending invitation. However, the present application is not limited thereto. The media can be text, phone or letter as long as the attesting witness can access the system.

Next, the attesting witness can select to decline or accept for notary. Specifically, as shown in step 340, if the attesting witness decline to sign for the documents, the system may send a notification to the contractors for modification as shown in step 342. The contractors, then, may review their previous documents and select to re-upload modified documents as shown in step 344 or reject to modify as shown in step 346. If the contractors re-upload the modified documents, the attesting witness may receive a new invitation again for notary. However, if the contractors reject to modify the documents, the system may remove the attesting witness who decline the notary. In other words, the contractors may need to find out others for notary if necessary.

On the other hand, as shown in step 350, if the attesting witness accept all the documents of the digital contract document, the digital contract document will be generated after confirmation from the contractors. After that, the digital contract document will be stored to the cloud system after all of the attesting witness' acceptance as shown in step 400.

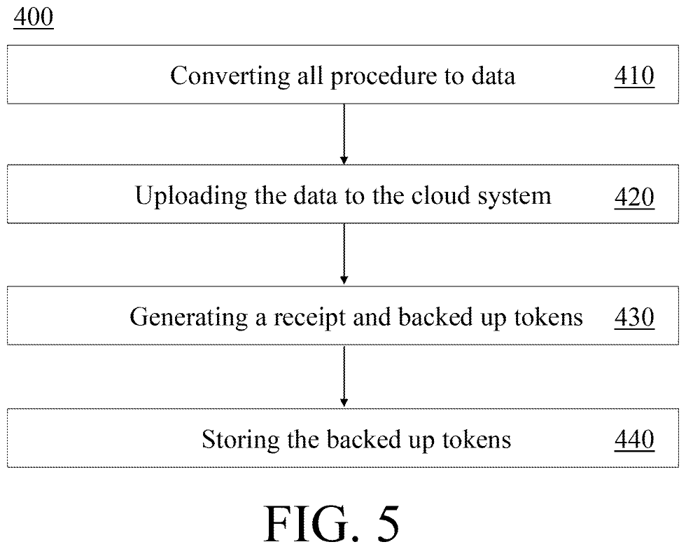

FIG. 5 is a flow chart showing the cloud system step 400 of the method 10 for encrypting digital contract document between contractors.

It should be noted that the storing step for the backed up token can be utilized for the tokens described in FIG.

Referring to step 410, the system may convert all of the above procedure to data. After that, as shown in step 420, the system may automatically upload the documents to the cloud system. Specifically, the cloud system only allows each case to upload the documents for one time. In addition, after the uploading process is completed, the cloud stored documents is only readable but not modified.

Referring to step 430, the system may generate a receipt of the digital contract document and backed up tokens for the contractors and/or attesting witness after uploading. Specifically, the receipt comprises a hash code such as QR hash code for the attesting witness to access for viewing the digital contract document. In addition, the attesting witness can also utilize the backed up tokens as a key to view the digital contract document.

FIG. 6 is a flow chart showing a self-transaction step within the contracting step and the cloud system step.

The present application utilizes smart contract as the self-transaction mechanism. Specifically, as shown in step 510, after generating token/backed up token as shown in step 216 and step 430, a server may create an order ID for each digital contract document. It should be noted that if it is in the contracting step, the video hash code and the document hash code may also be generated at the same time by the server.

The digital contract may be stored in the block chain as shown in step 520. Specifically, this blockchain comprises many smart contracts owned by different users. The server is Ubuntu server in the present application, but is not limited thereto.

As shown in step 530, the token/backed up token are saved under names of each of the contractors and/or attesting witness. Or, the system may also send the token/backed up token to private wallets of the attesting witness upon request for high secured purpose as shown in, step 540.

FIG. 7 is a flow chart showing the deleting step 600 of the method 10 for encrypting digital contract document between contractors.

The deleting step 600 is an optional step, the contractors and the attesting witness can delete the digital contract document on the cloud system if needed. However, all tokens from the contractors and the attesting witness are required to delete the digital contract document as shown in step 610 and step 620.

The tokens of the present application are generated on the ERC721 chain. However, the present application is not limited to.

Based on the above, the present application improves the authenticity of the digital documents by utilizing visual and audio verifications. Specifically, the hash codes are unreplaceable since the hash code represents the initiating time of the video, creating an uncompromised key for the digital contract documents. In addition, a recording procedure may also provide a second protection for the digital contract documents since the hash codes, tones, and frequencies of each involved members are different.

Furthermore, the original documents can have better protection because the tokens from every parties such as the contractors and/or the attesting witness are required for deleting, reducing the dispute caused by unilateral deletion of the digital contract document.

Furthermore, the original documents can have better protection because the tokens from both contractors and attesting witness are required for deleting, reducing the dispute caused by unilateral deletion of the digital contract document.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A method for encrypting digital contract document between contractors, comprising:
uploading a digital document to a system by at least one contractor;
initiating video signatures by the contractors;
generating respective hash codes by the system for each of the video signatures;
generating legal agreements by the system, wherein the respective hash code is displayed at each of the legal agreements; and
recording while reading the respective hash codes at the legal agreements orally by the contractors.

2. The method for encrypting digital contract document between contractors as claimed in claim 1,
wherein the step of generating the respective hash codes by the system for each of the video signatures further comprises generating respective tokens by the system.

3. The method for encrypting digital contract document between contractors as claimed, in claim 2, wherein the step of generating the respective tokens for the contractors comprises implanting the respective hash codes into the respective tokens by the system.

4. The method for encrypting digital contract document between contractors as claimed in claim 2, wherein after generating the respective tokens for the contractors, the method further comprises storing the respective tokens under names of the contractors respectively at the system.

5. The method for encrypting digital contract document between contractors as claimed in claim 2, wherein after recording while reading the respective hash codes at the legal agreements orally by the contractors, the method further comprises:
converting all procedure to data; and
uploading the data to a cloud system.

6. The method for encrypting digital contract document between contractors as claimed in claim 5, wherein after uploading the data to the cloud system, the method further comprises:
generating receipts and backed up tokens, wherein the backed up tokens are the same as the respective tokens; and
distributing the receipts and the backed up tokens to the contractors.

7. The method for encrypting digital contract document between contractors as claimed in claim 6, wherein the step of generating the receipts and the backed up tokens comprises generating a hash code for each of the receipts.

8. The method for encrypting digital contract document between contractors as claimed in claim 7, wherein after generating the receipts and the backed up tokens, the method further comprises scanning the hash code to view the digital contract document.

9. The method for encrypting digital contract document between contractors as claimed in claim 7, wherein the hash code is a QR hash code.

10. The method for encrypting digital contract document between contractors as claimed in claim 6, wherein after distributing the backed up tokens to the contractors, the method further comprises deleting the digital contract document on the cloud system by using the tokens or the backed up tokens from the contractors.

11. The method for encrypting digital contract document between contractors as claimed, in claim 6, wherein after distributing the receipts and the backed up tokens to the contractors, the method further comprises storing the backed up tokens under names of the contractors at the system.

12. The method for encrypting digital contract document between contractors as claimed in claim 1, wherein after uploading the digital document to the system by the at least one contractor, the method further comprises sending an invitation by the contractors to an attesting witness; and accepting the invitation by the attesting witness.

13. The method for encrypting digital contract document between contractors as claimed in claim 12, wherein the step of initiating the video signatures by the contractors comprises initiating the video signatures by the contractors and the attesting witness.

14. The method for encrypting digital contract document between contractors as claimed in claim 13, wherein the step of generating the respective hash codes by the system for each of the video signatures further comprises generating respective tokens for the contractors and the attesting witness by the system.

15. The method for encrypting digital contract document between contractors as claimed in claim 14, wherein the step of generating the respective tokens for the contractors and the attesting witness by the system comprises implanting the respective hash codes into the respective tokens by the system.

16. The method for encrypting digital contract document between contractors as claimed in claim 14, wherein after generating the respective tokens for the contractors and the attesting witness, the method further comprises storing the respective tokens under names of the contractors and the attesting witness respectively at the system.

17. The method for encrypting digital contract document between contractors as claimed in claim 12, wherein the step of recording while reading the respective hash codes at the legal agreements orally by the contractors comprises recording while reading the respective hash codes at the legal agreements orally by the contractors and the attesting witness.
